(19) United States
(12) Patent Application Publication
(10) Pub. No.: US 2008/0188095 A1
(43) Pub. Date: Aug. 7, 2008

(54) ELECTRONIC CONNECTOR FOR CONTROLLING PHASE RELATIONSHIP BETWEEN SIGNALS

(76) Inventors: Robert Joseph Christopher, Chapel Hill, NC (US); Pravin Patel, Cary, NC (US); Tony Carl Sass, Fuquay Varina, NC (US)

Correspondence Address: IBM CORPORATION (SS/NC);c/o STREETS & STEELE, 13831 NORTHWEST FREEWAY, SUITE 355, HOUSTON, TX, 77040, US

(21) Appl. No.: 11/670,015

(22) Filed: Feb. 1, 2007

(51) Int. Cl. H01R 12/00

(52) U.S. Cl. 439/66

(57) ABSTRACT

Connector and methods of connector design and manufacture are disclosed for achieving a desired phase relationship between signals carried along conductors of different lengths, while maintaining a desired impedance of the conductors. In one embodiment, a PCB connector includes a first plurality of electronic terminals and a second plurality of electronic terminals disposed on a connector body. A substrate has a dielectric constant that varies with location within the substrate. A first electronic conductor follows a first pathway within the substrate to experience a first effective dielectric constant. A second electronic conductor follows a second pathway within the substrate to experience a second effective dielectric constant. The first electronic conductor is longer than the second electronic conductor and the first effective dielectric constant is less than the second effective dielectric constant, to at least reduce phase error between signals. By satisfying the relationship l₁/l₂=sqrt(ε₂/ε₁), a phase error may be avoided.

### BACKGROUND OF THE INVENTION

1. Field of the Invention

The present invention relates to electronic connectors having multiple parallel conductors.

2. Description of the Related Art

“Right-angle” connectors are sometimes used to interconnect circuit boards that are perpendicular to each other, such as server blades connected to a midplane. Right-angle connectors typically have two perpendicular faces with multiple rows and columns of electronic terminals (“pins”) on each face. Electrically conducting pathways (“conductors”) bridge the pins on one face to the corresponding pins on the other face. For example, the conductors may be conductive pathways etched, inlaid or deposited on a substrate. Because the length of a conductor within a connector depends upon the location of the pins that it bridges, all the conductors in a common column will have the same length, but the conductors in one column will have a different length than the conductors in a different column.

It is often desirable that signals traveling through a connector take the same amount of time to propagate the length of their respective wires. For example, high-speed signal interconnections are commonly wired as differential pairs. When a differential pair is passed through a right-angle connector, it is possible that each side of the differential pair is conveyed by a conductor of different length. If so, the two complementary signal components of the differential pair must travel different distances to traverse the connector. Assuming no phase error upon entry to the connector, the difference in distance traveled introduces a phase error in the signal components that emerge from the connector.

To eliminate phase errors from signals exiting a right-angle connector, board designers will typically introduce a compensating phase error just before entering or just upon exiting the connector. Introduction of a compensating phase error means that one of the wires in the differential pair must be lengthened relative to the other so that the distance traveled through the phase compensator plus the distance traveled through the connector is the same for both wires. Wires can be lengthened by adding serpentine curves or “zig-zags.” Unfortunately, adding extra length to one side of a differential pair may reduce the number of available wiring channels, which can translate into added cost for the board. The extra length also perturbs the impedance characteristics of the differential pair, giving rise to undesirable effects, such as reflections, that may compromise signal quality.

In view of the drawbacks and limitations of conventional connectors, an improved connector is desired. Among other things, the improved connector would preferably prevent or minimize a phase error in two signals exiting the connector. It would be desirable if the improved connector could manage a phase relationship between two signals passing through the connector. It would also be desirable if the improved connector could be implemented as an angled connector having conductors with different path lengths.

### SUMMARY OF THE INVENTION

In a first embodiment, a connector comprises a connector body. A first plurality of electronic terminals and a second plurality of electronic terminals are disposed on the connector body. A first electronic conductor is disposed on a first dielectric material having a first dielectric constant. The first electronic conductor provides electronic communication between one of the first plurality of electronic terminals and one of the second plurality of electronic terminals. A second electronic conductor is disposed on a second dielectric material having a second dielectric constant. The second electronic conductor provides electronic communication between another of the first plurality of electronic terminals and another of the second plurality of electronic terminals. The first electronic conductor is longer than the second electronic conductor, the first and second electronic conductors have substantially the same impedance, and the first dielectric constant is less than the second dielectric constant. Optionally, the first plurality of terminals may be aligned in a first plane, such as on a first face of the connector, the second plurality of terminals may be aligned in a second plane, such as on a second face of the connector, and the first and second planes or faces are typically angled with respect to one another.

In a second embodiment, a connector comprises a connector body. A first plurality of electronic terminals and a second plurality of electronic terminals are disposed on the connector body. A substrate has a dielectric constant that varies with location within the substrate. A first electronic conductor has a first pathway within the substrate and a corresponding first effective dielectric constant with respect to the first electronic conductor. The first electronic conductor provides electronic communication between one of the first plurality of electronic terminals and one of the second plurality of electronic terminals. A second electronic conductor has a second pathway within the substrate and a corresponding second effective dielectric constant with respect to the second electronic conductor. The second electronic conductor provides electronic communication between another of the first plurality of electronic terminals and another of the second plurality of electronic terminals. The first electronic conductor is longer than the second electronic conductor, the first and second electronic conductors have substantially the same impedance, and the first effective dielectric constant is less than the second effective dielectric constant. Preferably, the first and second electronic conductors line in a plane that includes the respective electronic terminals.

In a third embodiment, a method of manufacturing a connector is provided. A first conductor is formed having a first conductor length, a first conductor thickness, and a first conductor width. A second conductor is formed having a second conductor length, a second conductor thickness, and a second conductor width. A substrate is formed having a dielectric constant that varies with location within the substrate. The first conductor is disposed along a first pathway within the substrate to provide a first effective dielectric constant with respect to the first conductor. The second conductor is disposed along a second pathway within the substrate to provide a second effective dielectric constant with respect to the second conductor. The first conductor length is greater than the second conductor length, the first and second electronic conductors have substantially the same impedance, and the first effective dielectric constant is less than the second effective dielectric constant.

Other embodiments, aspects, and advantages of the invention will be apparent from the following description and the appended claims.

### BRIEF DESCRIPTION OF THE DRAWINGS

FIG. 1A is an exploded schematic view of a PCB assembly having an insulating substrate.

FIG. 1B is an assembled view of the single integrated PCB assembly.

FIG. 1C shows several integrated PCB assemblies stacked parallel to each other to be inserted into a connector body.

FIG. 2 is a schematic, partially-exploded view of one embodiment of a simplified PCB assembly according to the invention.

FIG. 3A is a schematic, perspective view of an alternative embodiment of a wafer assembly according to the invention.

FIG. 3B is a table of the symbols used to characterize the dimensions of a conductor and the dielectric constant of a substrate according to the present invention.

FIG. 4 is a cross-sectional diagram of a substrate having a dielectric constant that varies with depth.

FIG. 5 is a flowchart illustrating a method of designing and manufacturing a connector according to the invention.

### DETAILED DESCRIPTION

Embodiments of the invention include connectors that propagate signals from one device to another along different pathways without introducing a phase error. The velocity of signals is varied in a manner that offsets differences in the length of conductors that propagate the signals. A common predetermined impedance is also provided for all of the different conductor pathways. Thus, a pair of signals will enter and exit a connector in substantially the same phase relationship while encountering the same impedance. The ability to control phase relationship. The control of phase relationship between signals traveling through two wires of a differential pair is one particularly useful application of the invention. However, the invention is not limited to use with differential pairs, and is more generally applicable to controlling phase relationship between and impedance of two or more conductors. Phase compensation within the connector may be achieved without equalizing the total length of the conductors and wires in the differential pair, thereby allowing more efficient utilization of the available wiring channels. Among other benefits, this minimizes undesirable effects, such as reflections, that may otherwise compromise signal quality. Furthermore, phase skewing (resulting from this path mismatch) can introduce common-mode signals which, in turn, can lead to EMC issues. Thus, phase compensation prevents the introduction of undesirable common-mode signals on to the differential pair. Additionally, eliminating a need to add length to one side of the differential pair of conductors in the PCB will eliminate an impedance discontinuity. For example, zig-zagging one wire in the pair disrupts the differential impedance of the pair.

In one embodiment, a connector is used to connect electronic devices disposed at an angle to one another. For example, the connector may be a right-angle connector for connecting a blade server perpendicularly to a midplane. The connector includes a plurality of terminals (which may be “pins”) arranged in rows and columns on perpendicular connector faces, so that the terminals on one face plug into one electronic device and the terminals on the other face plug into the other electronic device. Electronic pathways are provided in the form of conductors etched or inlaid on a wafer substrate, providing electronic communication between terminals on one face and terminals on the other face. The conductors have different lengths depending on the position of the terminals on the connector. To compensate for a signal phase lag that would normally occur over these differences in length, the velocity of signals transmitted through the conductors is controlled by disposing the conductors on dielectric materials having different dielectric constants. Specifically, the phase relationship of signals passing through the connector may be held constant by satisfying the relationship l₁/l₂=sqrt(ε₂/ε₁), where l₁ and l₂ are the lengths of the conductors and ε₁ and ε₂ are the effective dielectric constants of the respective dielectric materials. Simultaneously, cross-sectional geometries and dimensions of the conductors are determined, such as with a commercially available impedance calculator, so that the conductors of different lengths will present the same impedance.

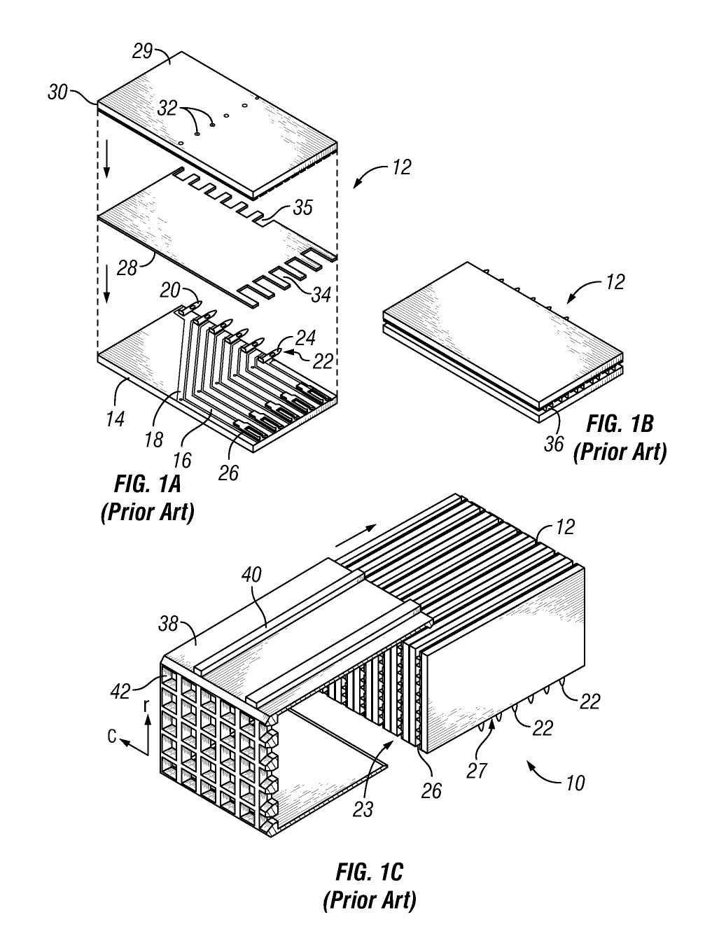

FIGS. 1A through 1C show a simplified configuration of a conventional (prior art) right angle connector 10 in stages of assembly using standard printed circuit boards to carry electronic conductors, in which a single copper layer may be sandwiched between two dielectric layers.

FIG. 1A is an exploded schematic view of one example of a PCB assembly 12 having an insulating substrate 14, formed for example of conventional flat PCB material. A plurality of separate conductors 16 are disposed on the substrate 14, and may either be on a surface of the substrate 14 or embedded within the substrate 14. In this PCB assembly 12, the conductors 16 will be sandwiched between the substrate 14 and an insulating cover plate 30 (see FIG. 1B). The substrate 14 and the insulating cover plate 30 may each have an associated dielectric constant. The dielectric constant of the substrate 14 may be the same or different from the dielectric constant of the cover plate 30, and together may provide an “effective” dielectric constant about the conductors 16. Conducting ground tracks 18 may be provided between adjacent conductors 16. The outermost conductor 16 is provided with a ground electronic terminal 20 to be connected to ground through the printed circuit board to which the connector is to be connected. Methods of producing an insulating substrate 14 with separate conductors 16 are widely known in the field of manufacturing printed circuit boards and need not be explained here.

Each of the conductors 16 is connected to electronic terminals 22, with board contact portions 24 extending beyond the edge of the insulating substrate 14. Although the electronic terminals 22 are shown as press-fit terminals they might be replaced by other terminals known in the art, such as solder tail terminals or surface mount terminals. The gender (or lack thereof) of the electronic terminals 22 is not crucial to the invention, and may be selected according to a particular application as desired by a connector designer. The other ends of the conductors 16 are connected to electronic terminals 26.

An insulating spacer 28 and an insulating cover plate 30 with a fully metallized ground layer 29 are also provided. An insulating spacer 28 is provided having a first series of cutouts or openings 34 for accommodating the additional thickness of the electronic terminals 26 and a second series of openings 35 for accommodating the additional thickness of at least part of the electronic terminals 22. Each of the insulating cover plates 30 may be provided with suitable conductors, one end of which is electrically connected to one of the electronic terminals 26 and the other end of which is electrically connected to the electronic terminal 22. These conducting tracks may be provided in a mirrored relation to the conducting tracks 16 on the insulating substrate 14. Cover plate 30 may also be provided with ground tracks between the conducting tracks on the cover plate 30. These ground tracks are preferably connected to the ground layer 29 by means of plated through-holes 32. In other connectors, additional through-holes 32 may be included. The manufacturing and use of plated through-holes is known to persons skilled in the art and need no further explanation.

The conducting ground tracks typically must attach to terminals in both faces 23, 27 of the connector. These provide signal return paths. They can alternately be replaced with solid metal ground layer(s) on the opposite side of the substrate 14 and in the center of the spacer 28. In that case, the solid ground plane(s) must have terminals that, again, allow it to connect through both faces of the connector.

FIG. 1B is an assembled view of the single integrated PCB assembly 12. Openings 34 in the insulating spacer 28 (FIG. 1A) form recesses 36, in which the female-type electronic terminals 26 are disposed to receive electronic terminals of a mating connector (not shown). It is to be understood that the female-type electronic terminals 26 shown in FIG. 1A may be replaced by male-type or other types of electronic terminals.

FIG. 1C shows several integrated PCB assemblies 12 stacked parallel to each other to be inserted into a connector body 38. The connector body 38 may be made of any insulating material and may be provided with a metallized outer surface to enhance the shielding effectiveness. The connector body 38 may be provided with suitable guiding ridges 40 for properly connecting the assembled connector to a mating connector (not shown). Preferably, each of the integrated PCB assemblies 12 have at least one ground layer 29 on one of their main outer surfaces to shield the parallel integrated PCB assemblies 12 from each other. Both outer surfaces of each of the outer integrated PCB assemblies 12 in the configuration shown in FIG. 1C are preferably provided with ground layers 29 to enhance the shielding effectiveness.

The electronic terminals 22 are arranged along a face 27 of the connector body 38, and the electronic terminals 26 are arranged along a face 23 of the connector body 38. The connector 10 is a right-angle connector, wherein the faces 23, 27 are perpendicular to one another and the electronic terminals 22 are perpendicular to electronic terminals 26. The connector body 38 is provided with suitable lead-in holes 42 in corresponding relationship with each of the electronic terminals 26. Each of the lead-in holes 42 is suitable for receiving a mating male-type electronic terminal of a mating connector (not shown). The lead-in holes 42 and corresponding electronic terminals 26 are arranged in columns (“c”) and rows (“r”). It may be observed that the electronic conductors 16 connecting all the electronic terminals 22, 26 in a given column (left to right in FIG. 1C) are the same length, while the electronic conductors 16 connecting all the electronic terminals 22, 26 in a given row (up and down in FIG. 1C) are of different lengths. In a conventional connector, such as the example of FIGS. 1A-1C, the different length conductors within a row introduce a phase error, in that signals take longer to propagate through longer conductors. Each PCB plate 12 provides substantially the same effective dielectric constant to each of the electronic conductors 16. Thus, a given signal will travel through different electronic conductors 16 at substantially the same velocity, such that the signal will take longer to travel the length of the longer electronic conductors 16. Thus, signals having a phase relationship at the point of entering the prior art angled connector 10 in different rows will emerge from the connector 10 with a phase error.

Embodiments of the present invention include both new angled connector designs and improvements to conventional angled connectors, such as improvements to the conventional connector of FIG. 1A-1C. It should be recognized that the type of PCB connector described above is just one example of a connector to which the invention may be applied. More commonly, a PCB connector may comprise a lamination of two or more double-sided “cores,” wherein one side of each core would serve as a ground or reference plane. One skilled in the art will recognize other PCB connector types and configurations that may be created or adapted according to the invention.

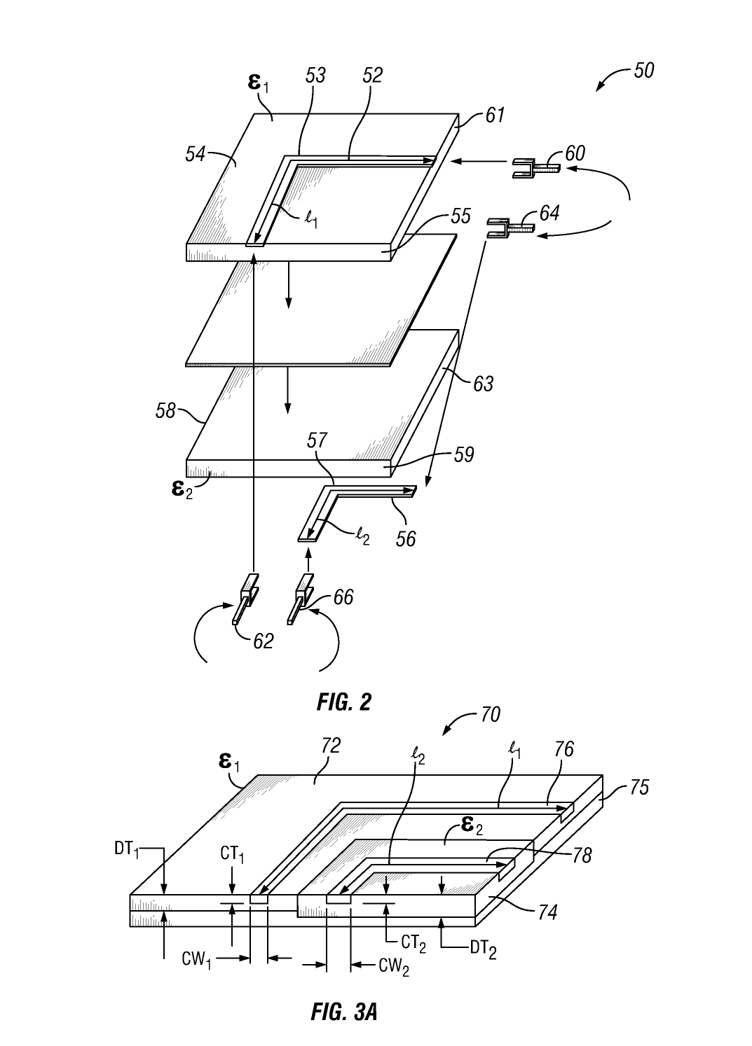

An angled connector, such as those mentioned above, may be created or adapted according to the invention to control the phase relationship between signals while maintaining a predetermined impedance to the signals. FIG. 2 is a schematic, partially-exploded view of one embodiment of a simplified PCB assembly 50 according to the invention. The PCB assembly 50 may be used in a right-angle connector to transmit signals through conductors of different lengths without introducing an appreciable phase error. A first (longer) conductor 52 having a length 1 is disposed on a first wafer 54, and a second (shorter) conductor 56 l₂ is disposed on a second wafer 58, such that l₁>l₂. The conductors 52, 56 each have, respectively, a bend 53, 57 to extend from faces 55, 59 to faces 61, 63 that are generally perpendicularly disposed with respect to the faces 55, 59. Other embodiments may have other bends or non-perpendicular faces. The lengths l₁ and l₂, are the distance that a signal will travel along the respective conductors 52, 56, which naturally follows the path of the conductor including the bends 53, 57. The first and second wafers 54, 58 comprise dielectric materials of dissimilar dielectric constants. The first wafer 52 has a dielectric constant ε₁ and the second wafer 54 has a dielectric constant ε₂. The wafers 54, 58 may each comprise a homogenous dielectric material, so that the dielectric constants ε₁ and ε₂ are substantially unvarying throughout the respective wafers 54, 58. Alternatively, the wafers 54, 58 may each comprise heterogeneous dielectric materials of varying dielectric constants, such that ε₁ and ε₂ are “effective” dielectric constants relative to their respective conductors 52, 56. Electronic terminals in the form of pins 60, 62 are provided at ends of the longer conductor 52, and electronic terminals in the form of pins 64, 66 are provided at ends of the shorter conductor 66.

The different conductor lengths l₁ and l₂ are selected to accommodate the dielectric constants ε₁ and ε₂. If ε₁ and ε₂ were equal, a pair of signals arriving in phase at pins 60 and 64, respectively, would traverse the conductors 52, 56, and arrive at pins 62, 66 out of phase with one another. According to the invention, however, unequal lengths l₁ and l₂ may be selected in consideration of the different dielectric constants ε₁ and ε₂ to reduce or eliminate phase error. In general, selecting the dielectric constant ε₂ to be greater than the dielectric constant ε₁ reduces any phase difference imparted by the PCB assembly 50. The phase difference may be eliminated if the values of l₁, l₂, ε₁, and ε₂ are selected satisfy the relationship l₁/l₂=sqrt(ε₂/ε₁). In other words, it may be said that the ratio of the length (l₁) of the first electronic conductor to the length (l₂) of the second electronic conductor is substantially equal to the square root of the ratio of the second dielectric constant (ε₂) to the first dielectric constant (ε₁).

For simplicity of illustration, only two wafers 54, 58 are shown in the assembly of FIG. 2, each having a single conductor 52, 56. When sandwiched together, the combined wafers 54, 58 form a relatively simple connector portion with only two conductors 52, 56. As part of a larger connector, the different-length conductors 52, 56 would preferably be disposed in the same “row” according to the convention established herein. To build a connector having more than two rows, and also having multiple columns, additional wafers could be constructed and layered with the wafers 54, 58. To increase the number of conductors in a row, additional conductors of varying lengths could be included on the wafers 54, 58. Furthermore, multiple columns could be provided by stacking multiple instances of the assembly in FIG. 2. Thus, conductors may be arranged on the wafers and the wafers may be stacked in such a way that multiple columns and rows are provided, wherein each conductor in a column preferably has the same length, and each conductor in a row preferably has a different length. Generally, however, it is not necessary that in every embodiment all conductors in a given column have the same length and that all conductors in a given row have a different length.

Maintaining a predetermined impedance in the conductors of the connector is important for avoiding signal reflections as signals enter and exit the connector. Impedance mismatches give rise to reflections. Reflections degrade signal quality in several ways: a) a loss of signal power delivered to an intended destination results in reduced signal amplitude at receiver, b) reflected signals can interfere with intended signal in such a way as to cause false transitions, eye closure, jitter, and/or overshoot, c) mismatched reflections can give rise to common mode signals. It is typically easier to select dielectric constants first, then manipulate cross-sectional geometries and lengths to accommodate the dielectric constants. This is because choice of materials is more constrained, with fewer degrees of freedom. Conductor geometries and dielectric thicknesses are far more easily manipulated.

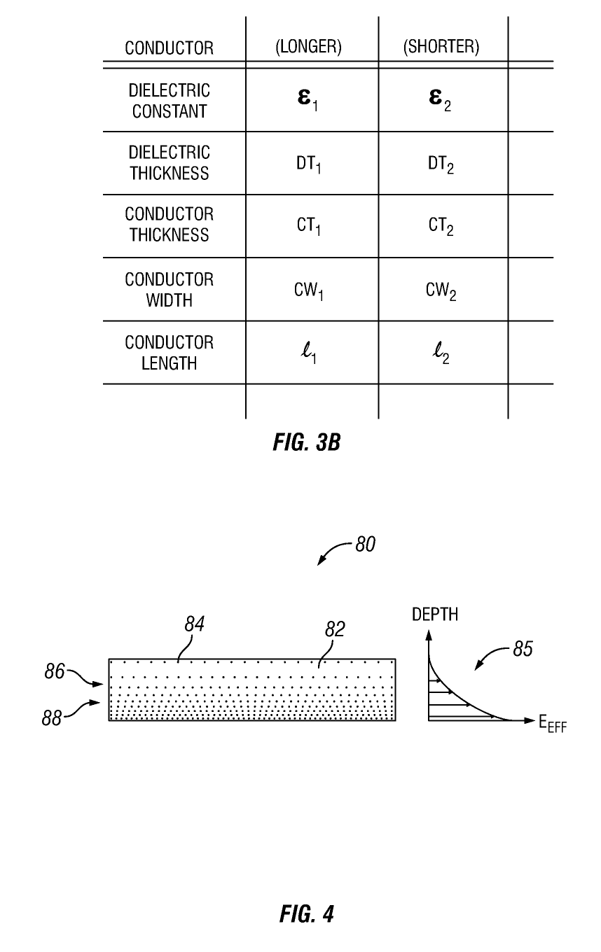

FIG. 3A is a schematic, perspective view of an alternative embodiment of a wafer assembly 70 according to the invention. The wafer assembly 70 maintains a desired phase relationship while simultaneously maintaining a predetermined impedance for the conductors. A composite substrate includes a first substrate portion, which in this embodiment is a first wafer 72, and a second substrate portion, which in this embodiment is a second wafer 74, both of which are disposed on a base layer 75. The first wafer 72 and second wafer 74 may be bonded with each other and/or with the optional base layer 75. A first (longer) conductor 76 having a length l₁ has a pathway along the first wafer 72 and a second (shorter) conductor 78 having a length 12 has a pathway along the second wafer 74. The dielectric constant of the composite substrate varies with location within the composite substrate, in that the first wafer 72 comprises a dielectric material ε₁ and the second wafer 76 comprises a dielectric material ε₂, wherein ε₂>ε₁ to compensate for the differences in conductor length. The same principles of selecting dielectric constants discussed with respect to FIG. 2 apply to FIG. 3A, so that the parameters l₁, l₂, ε₁, and ε₂ may be selected to satisfy the relationship l₁/l₂=sqrt(ε₂/ε₁). It is generally easier to first select dielectric constants, and vary length accordingly. Alternatively, these parameters may be varied to alter the phase relationship of signals in another way, as desired. For example, if it is anticipated that signals will enter the conductors 76, 78 with a known phase difference, these parameters may be selected to offset that phase difference so that signals will exit the conductors 76, 78 with a different phase difference, such as no phase difference.

An important aspect of the embodiment is imparting a desired impedance to the conductors in a connector. Signals propagate in the medium between the signal conductors and the signal return path at a velocity dictated by the effective dielectric constant of the medium. Typically, signal return paths are provided in connectors by pins which connect the ground (or reference) layers(s) of the PCBs being connected. In a PCB-type of wafer construction, the ground pins would most likely connect to ground layers in the wafers. The signal conductors in those wafers would be said to be “referenced” to the ground layers. Alternatively, ground conductors may be interspersed with signal conductors, similar to what is illustrated in FIG. 1A. The base layer 75 may alternatively serve as a ground or reference plane that provides a path for return currents.

Parameters of the wafer assembly 70 may also be selected to maintain a predetermined impedance for the conductors 76, 78. FIG. 3A labels some dimensional parameters of various elements of the wafer assembly 70. The first wafer 72 has a dielectric thickness dt₁. The first conductor 76 has cross-sectional dimensions that include a conductor thickness ct₁ and a conductor width cw₂. Likewise, the second wafer 74 has a dielectric thickness dt₂. The second conductor 78 has cross-sectional dimensions that include a conductor thickness ct₂ and a conductor width cw₂. These dimensions may be selected to attain the desired impedance for each of the conductors 76, 78, such as to match the impedance of the first conductor 76 with the impedance of the second conductor 78. For example, a commercially available impedance calculator may be used to select these parameters so that the impedances of the first and second conductors 76, 78 are matched (equal).

These dimensions are shown in tabular form in FIG. 3B, for reference. In one example, a longer conductor having length 0.500″ and a shorter conductor having length 0.454″ may require ε₁=3.8 and ε₂=4.6 according to the relation l₁/l₂=sqrt(ε₂/ε₁). Next, the parameters listed in FIG. 3B may be selected to achieve a target impedance of 50 ohms for each of the conductors 76, 78. Using a commercially available impedance calculator, setting dt₁=0.0081″, ct₁=0.0012″, and cw₂=0.015 will achieve the desired impedance of 50 ohms for the first conductor 76. Selecting dt₂=0.0122″, ct₂=0.0012, and cw₂=0.020″ will achieve the desired impedance of 50 ohms for the second conductor 78. This is just one example of how materials having certain physical properties can be selected in order to control a phase relationship between signals through conductors having different lengths, and then the cross-sectional dimensions of the conductors and dielectric materials can be manipulated to realize a particular impedance in the conductors. This example illustrates the invention in the context of a printed circuit board, but other implementations are possible, such as molded leadframe assemblies, stitched contact assemblies, and coaxial assemblies.

The embodiments of FIGS. 2 and 3A have a composite substrate structure characterized by substrate portions or wafers having different dielectric constants. By comparison, FIG. 4 is a cross-sectional diagram of a substrate 80 having a dielectric constant that varies with depth. A matrix material (“matrix”) 82 may have a first dielectric constant that is optionally homogenous. Particles 84 are embedded within the matrix 82. The material properties of the particles 84, themselves, have a dielectric constant that differs from the dielectric constant of the matrix 82. The concentration of the particles 84 within the matrix 82 increases with depth. Accordingly, an effective dielectric constant may vary with depth within the substrate 80, as illustrated by graphical element 85, due to the changing density of the particles 84. Conductors of different lengths used for connecting between pins in a connector may be inlaid at different depths within the substrate 80, so that each conductor experiences a different effective dielectric constant. For example, a first conductor having a first length may be inlaid at a first depth 86, and a second conductor having a second length may be inlaid at a second depth 88. The depth of the conductors may be selected in consideration of conductor length to achieve a desired effective dielectric constant for each conductor, to control the phase relationship between signals passing through the conductors. For example, the depth of each conductor may be selected to satisfy the relationship l₁/l₂=sqrt(ε₂/ε₁). However, such determinations would have to be made in consideration of the signal return paths (e.g., conductors or ground/reference planes) used, since the propagation velocity is dictated by the effective dielectric constant of the medium between the signal conductor and the signal return path.

A number of ways are known in the art to manufacture a composite material in which particle concentration varies across a dimension of the material, i.e., establishing a concentration gradient. For example, electro-deposition processes may be used to precisely control the deposition of particles. The substrate thickness may be built up in layers, during which matrix material 82 and particles 84 are deposited in selected, controlled ratios for each layer. Alternatively, the matrix 82 and particles 84 may be mixed together while the matrix 82 is in liquid form, and the viscosity of the liquid form may allow the particles to partial settle due to gravity in a manner that varies particle concentration as a function of depth. As the matrix 82 cures, hardens, or otherwise solidifies the particles 84 are thereby captured at their fixed locations within the matrix 82. Generally, these and other techniques known in the art may be used to achieve a substantially continuously variable particle concentration as a function of depth. By controlling particle concentration and selecting matrix 82 and particles 84 with desired dielectric properties according to the invention, a substrate may be manufactured having a substantially continuously variable dielectric constant as a function of a dimension, such as depth. In another embodiment, the dielectric constant in a substrate may be similarly varied in other dimensions, such as along a length, and in two or more dimensions at once, to selectively control the overall, effective dielectric constant with respect to a conductor. However, controlling impedance in such a scenario is potentially very challenging, in that conductor geometries would have to vary in a manner dictated by the variation in dielectric constant. Thus, such an embodiment would likely require a computationally-intensive design process performed on a computer.

The need for right-angle connectors is common, as many electronic components are designed to be connected at substantially right angles. Thus, the embodiments of FIGS. 2 and 3A illustrate components of right-angle connectors constructed according to the invention. Conductors used in right-angle connectors are generally required to traverse a bend for connecting between electronic components disposed at right angles. The conductors typically include bends to traverse the angle of the connector, which is typically responsible for the different conductor lengths within any given row. It should be observed, however, that the invention may be used to connect between components at other angles. For example, in some applications it may be desired to connect two electronic components at an acute or obtuse angle. These other angles will also generally lead to conductors having different lengths. Even zero-angle connectors may be designed with an architecture having conductors of different lengths, even though there is no angle between the components to be connected. Thus, though the invention is particularly useful with right-angle connectors, the invention may be applied to connectors of any angle, including connectors having no angle but whose conductor lengths vary for any other reason.

In another embodiment, the connector may be formed as an integral part of a component, such as a midplane, such that no terminals are needed at one end or face of the conductors designed according to the invention. It is also possible to integrate the connector between two components in a manner where no terminals are used at either end or face. In yet another embodiment, the invention may be used in the design of a circuit board to control the phase relationship between signals traveling on conductors of different lengths. Such a “connector” may connect two different sections of the same circuit board, rather than two separate devices, and would not require distinct terminals or a removable connector body. For example, where it is desired to control a phase relationship between signals traveling on two conductors having different lengths on a circuit board, a substrate included with the circuit board may be provided with a variable dielectric constant to control the phase relationship between the signals.

The invention encompasses not only connectors, but also methods of designing connectors. The various parameters discussed affecting phase relationship, such as conductor length and dielectric constants, may be selected according to the invention to achieve the desired phase relationship between signals passed through different conductors. The various parameters discussed affecting conductor impedance may also be selected according to the invention to achieve the desired impedances.

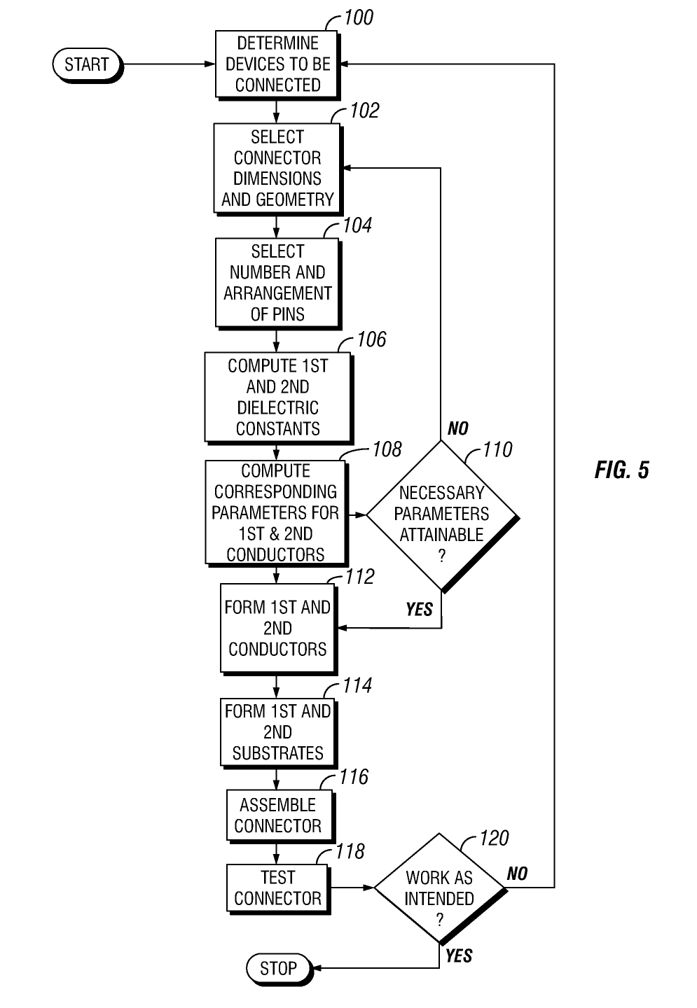

FIG. 5 is a flowchart illustrating a method of designing and manufacturing a connector according to the invention. The flowchart of FIG. 5 generally outlines the approach to designing a connector with a desired signal phase relationship (such as zero phase difference between signals) and target impedances (such as equal impedance for the conductors). However, the flowchart is not intended to be an exhaustive treatment of all possible steps and combinations of steps that may be used in the design and manufacture of a connector according to the invention. The process of designing an electronic component such as a connector frequently entails optimization through a process of iteration. Thus, various steps may be performed and repeated, using different selections of connector parameters, until the optimal result is obtained. Therefore, the sequence of steps is not limited to the order in which the steps are shown and discussed, and one skilled in the art having the benefit of this disclosure will be able to select a suitable order (and possibly repetition) of steps for a given application.

In step 100, the devices to be connected are preliminarily determined. Non-limiting examples of parameters to be considered include: the type of devices to be connected, such as server blades to be connected to midplanes or PCI cards to be connected to motherboards; the desired location and orientation of the devices within an enclosure, including the angle between the devices to be connected; and the number and spatial relationship between electronic terminals of the devices. A manufacturer may, for example, select a particular product line, either already in production or to be designed in conjunction with the connector(s). Because electronic devices are typically produced on an “assembly line” using interchangeable parts and predictable, repeatable dimensions, a single connector may be economically designed and produced in quantity for a particular product line or models of devices to be connected.

In step 102, the geometry and dimensions of a connector body may be devised according to the devices and device parameters determined in step 100. Considerations include the need to optionally mechanically couple the two devices, which helps assure reliability of the electronic connections to be made. One consideration is whether the connector will be used to connect two devices at an angle. For example, it may be determined in step 102 that a right-angle connector is most suitable for connecting the devices selected in step 100. It will also be useful to select locations of holes in a connector body through which electronic terminals (both those of the connector and those of the devices to be connected) may extend. Step 102 will largely determine whether conductors disposed in the connector body will require any bends or other architecture that may require conductors having different lengths. In step 104, the number and arrangement of electronic terminals or “pins” is selected. This step may be performed in conjunction with or prior to step 102, so that the number and location of pins corresponds with the number and location of holes in the connector body.

After a desired mechanical configuration is selected, steps may be performed to achieve a desired phase relationship between signals carried along conductors of different lengths, while maintaining a desired impedance of the conductors. In step 106, first and second dielectric constants may be selected to control the rate of signal propagation through the conductors and the phase relationship between signals. For example, these dielectric constants may be selected so that signals entering the connector in phase will exit the connector in phase. Generally, the longer conductor will be disposed on a substrate having a lower dielectric constant than the substrate on which the shorter conductor is disposed. In this regard, the relationship l₁/l₂=sqrt(ε₂/ε₁) may be used as a guide in the selection of dielectric constants. Alternatively, the dielectric constants may be selected so that signals anticipated to arrive at the connector out of phase will be compensated for and emerge from the connector in phase.

Because the phase relationship will depend on both dielectric constants and conductor lengths, and because conductor geometry, substrate thickness, and other parameters affect the impedance of the conductors, the selection of dielectric constants in step 106 may be performed in conjunction with the selection of conductor parameters, which will be selected in step 108. However, although the lengths l₁, l₂ and the dielectric constants ε₂, ε₁ are dependent upon one another, choice of materials is generally more constrained, while conductor geometries and lengths are more easily manipulated. Therefore, it may be easier to first select dielectric constants in step 106, and then manipulate cross-sectional geometries and lengths to accommodate the dielectric constants in step 108. The length, shape, and orientation of the conductors may also be influenced by the pin arrangement selected in step 104.

Again, the various steps may be performed in an iterative calculation process until the optimal combination of parameters is computed to obtain the target phase relationship and impedance. Depending on the design of the substrate (e.g. formed from homogenous substrate portions or a unitary substrate with continuously-variable dielectric properties) it may be easier to first select dielectric properties and then select conductor and substrate geometry dependent upon the dielectric properties. Alternatively, it may be determined at some point in the design process that for a given selection of some parameters, such as conductor length, that other parameters, such as dielectric constants necessary to achieve zero phase error, are not attainable. Whether the desired parameters are attainable is determined in conditional step 110. If not, any of the steps may be repeated in this iterative process until the desired combination of parameters effectively yields the desired end result, such as to achieve a connector that varies propagation velocity in a manner that offsets conductor length differences while simultaneously maintaining a predetermined impedance for the conductors.

Once the desired combination of parameters is found, then the conductors may be formed in step 112. The flowchart describes a simplified analysis wherein only two conductor lengths are to be included, though the principles discussed herein may be equally applied to connectors having three or more conductor lengths. In step 114, the first and second substrates are formed according to the parameters selected in step 110. The substrate may be formed from homogenous substrate portions (FIG. 3A) or a unitary substrate with continuously-variable dielectric properties (FIG. 4). Depending on the method of manufacture, formation of the substrate (step 114) may actually occur prior to or in conjunction with formation of the conductors (step 112). For example, a substrate may be etched to form the conductors on the substrate according to techniques known in the art. Alternatively, conductors may be formed and laid or inlaid on pre-formed substrates. In other embodiments, the conductors may be conventional wires laid in predefined grooves or pathways.

In step 116, the connector may be assembled, including positioning of the substrate within the connector body. In step 118, the connector may be tested on the intended devices in their desired configurations. The connector may be connected to both devices, and test signals may be sent to ensure proper signal transmission between the two devices. The phase relationship between signals may also be checked, along with the intended conductor impedance, to ensure the assembled connector has the desired parameters as computed in steps 106, 108. In conditional step 120, if tests confirm the connector works as intended, the initial design and manufacture is complete. If any of the parameters such as impedance and phase relationship deviate from what is predicted or computed, more than an acceptable amount, some or all of the steps 100 through 118 may be repeated until the desired parameters are achieved. Thus, testing and redesign of a manufactured connector prototype are potentially part of the iterative process of designing, optimizing, and manufacturing a connector according to the invention. Though a physical prototype may be useful in some circumstances, it is not essential. Rather, much of the design process may be performed “virtually,” using software.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A connector, comprising:
a connector body;
a first plurality of electronic terminals and a second plurality of electronic terminals disposed on the connector body;
a first electronic conductor disposed on a first dielectric material having a first dielectric constant, the first electronic conductor providing electronic communication between one of the first plurality of electronic terminals and one of the second plurality of electronic terminals;
a second electronic conductor disposed on a second dielectric material having a second dielectric constant, the second electronic conductor providing electronic communication between another of the first plurality of electronic terminals and another of the second plurality of electronic terminals; and
wherein the first electronic conductor is longer than the second electronic conductor, the first and second electronic conductors have substantially the same impedance, and the first dielectric constant is less than the second dielectric constant.

2. The connector of claim 1, wherein the ratio of the length of the first electronic conductor to the length of the second electronic conductor is substantially equal to the square root of the ratio of the second dielectric constant to the first dielectric constant.

3. The connector of claim 1, wherein cross-sectional dimensions of the first electronic conductor and cross-sectional dimensions of the second electronic conductor are selected to substantially match the impedance of the first electronic conductor with the impedance of the second electronic conductor.

4. The connector of claim 1, further comprising:
a first signal wire connected to the first electronic conductor and configured for conducting a first signal to the first electronic conductor; and
a second signal wire connected to the second electronic conductor and configured for conducting a second signal to the second electronic conductor.

5. The connector of claim 1, further comprising a differential pair that includes the first and second signal wire.

6. The connector of claim 1, wherein one or both of the first and second conductors have a bend between the electronic terminals.

7. The connector of claim 1, wherein the first and second plurality of terminals are substantially perpendicular.

8. The connector of claim 7, further comprising:
a first conductor face on which the first plurality of electronic terminals is disposed;
a second conductor face on which the second plurality of electronic terminals is disposed; and
wherein the first face and the second face are substantially perpendicular.

9. The connector of claim 1, further comprising a first wafer comprising the first dielectric material and on which the first electronic conductor is disposed and a second wafer comprising the second dielectric material and on which the second electronic conductor is disposed, wherein the first and second wafers are stacked.

10. The connector of claim 1, wherein the first and second dielectric materials are disposed on a common wafer.

11. A connector, comprising:
a connector body;
a substrate having a dielectric constant that varies with location within the substrate;
a first electronic conductor having a first pathway within the substrate and a corresponding first effective dielectric constant with respect to the first electronic conductor, the first electronic conductor providing electronic communication between a first pair of locations on the substrate;
a second electronic conductor having a second pathway within the substrate and a corresponding second effective dielectric constant with respect to the second electronic conductor, the second electronic conductor providing electronic communication between another pair of locations on the substrate; and
wherein a length of the first electronic conductor between the first pair of locations on the substrate is greater than a length of the second electronic conductor between the second pair of locations on the substrate, the first and second electronic conductors have substantially the same impedance, and the first effective dielectric constant is less than the second effective dielectric constant.

12. The connector of claim 11, further comprising:
a first plurality of electronic terminals including an electronic terminal at each of the first pair of locations; and
a second plurality of electronic terminals including an electronic terminal at each of the second pair of locations.

13. The connector of claim 11, wherein the ratio of the length of the first electronic conductor to the length of the second electronic conductor is substantially equal to the square root of the ratio of the second effective dielectric constant to the first effective dielectric constant.

14. The connector of claim 11, wherein cross-sectional dimensions of the first electronic conductor and cross-sectional dimensions of the second electronic conductor are selected to substantially match the impedance of the first electronic conductor with the impedance of the second electronic conductor.

15. The connector of claim 11, wherein the substrate comprises a plurality of substrate portions, each substrate portion having a different effective dielectric constant, wherein the first conductor is disposed on one of the substrate portions having the first effective dielectric constants and the second conductor is disposed on another of the substrate portions having the second effective dielectric constant.

16. The connector of claim 11, wherein the effective dielectric constant of the substrate varies according to depth within the substrate.

17. The connector of claim 11, further comprising:
a first signal wire coupled to the first electronic conductor and configured for conducting a first signal to the first conductor; and
a second signal wire coupled to the second electronic conductor and configured for conducting a second signal to the second conductor.

18. A method of manufacturing a connector, comprising:
forming a first conductor having a first conductor length, a first conductor thickness, and a first conductor width;
forming a second conductor having a second conductor length, a second conductor thickness, and a second conductor width;
forming a substrate having a dielectric constant that varies with location within the substrate;
disposing the first conductor along a first pathway within the substrate to provide a first effective dielectric constant with respect to the first conductor;
disposing the second conductor along a second pathway within the substrate to provide a second effective dielectric constant with respect to the second conductor; and
wherein the first conductor length is greater than the second conductor length, the first effective dielectric constant is less than the second effective dielectric constant, and the first and second conductors have substantially the same impedance.

19. The method of claim 18, wherein the ratio of the first conductor length to the second conductor length is substantially equal to the square root of the ratio of the second dielectric constant to the first dielectric constant.

20. The method of claim 18, wherein the first conductor thickness, first conductor width, second conductor thickness, second conductor width, first substrate thickness, and second substrate thickness are selected such that the first conductor and second conductor have substantially the same impedance.
